(19) United States
(12) Patent Application Publication
(10) Pub. No.: US 2006/0124190 A1
(43) Pub. Date: Jun. 15, 2006

(54) Fluoropolymer - EVOH - modified PA tube

(76) Inventor: Cyrielle Cheng, Saint-Jean De Monts (FR)

Correspondence Address: DYKEMA GOSSETT PLLC, Ste. 300, 39577 Woodward Ave., Bloomfield Hills, MI, 48304-2820, US

(21) Appl. No.: 11/302,292

(22) Filed: Dec. 13, 2005

(30) Foreign Application Priority Data
Dec. 13, 2004 (FR) 04 13211

(51) Int. Cl. F16L 11/00

(52) U.S. Cl. 138/137; 138/141; 428/36.91

(57) ABSTRACT

A tube comprising an inner layer of fluoropolymer, an intermediate layer of ethylene vinyl alcohol copolymer, and an outer layer of polyamide.

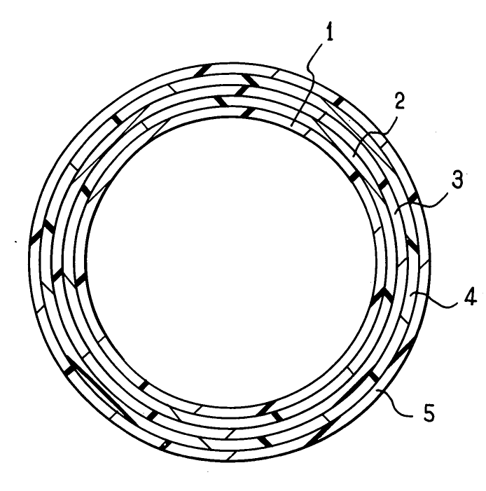

The present invention relates to a multilayer tube suitable in particular for transporting hydrogen, in particular in association with fuel cells.

### BACKGROUND OF THE INVENTION

Tubes for transporting hydrogen are known that are made of metal. The metal used is generally a stainless steel or an aluminum alloy. Such tubes are relatively heavy, which is penalizing for use in motor vehicles, and they are rigid, which makes them relatively difficult to install in a confined space, in particular. Furthermore, such tubes still run the risk of being corroded by the fluid they convey.

To mitigate that drawback, attempts have been made to make such tubes out of elastomer. Unfortunately, elastomer tubes have a relatively short lifetime, particularly since such tubes are poor at withstanding the fluids they convey. The poor ability to withstand the fluid being transported leads to degradation of the tubes and allows particles to be released into the fluid. Such particles run the risk of damaging the fuel cell or at least of affecting its operation. Such tubes are also relatively expensive.

### OBJECT OF THE INVENTION

It would therefore be advantageous to have a plastics material tube presenting better performance than known tubes.

### BRIEF SUMMARY OF THE INVENTION

To this end, the invention provides a tube comprising an inner layer of fluoropolymer, an intermediate layer of ethylene vinyl alcohol copolymer (EVOH), and an outer layer of polyamide (PA).

The tube made in this way presents low permeability to hydrogen and also to oxygen, carbon dioxide, sulfur dioxide, nitrogen oxides, . . . . Furthermore, the tubes degrade little or not at all in contact with the fluid being transported, so the transported fluid remains clean. The tube can also be relatively flexible in order to make it easy to install in the circuit. Manufacture of the tube is also relatively simple since it can be made by multilayer extrusion and it can be subsequently thermoformed, should that be necessary.

In a particular embodiment, the fluoropolymer is an ethylene tetrafluoroethylene (ETFE).

ETFE is particularly advantageous since this material presents low permeability to the above-mentioned gases and more particularly to hydrogen, it withstands high temperature and corrosion, and it possesses good chemical inertness and little ability to absorb water.

In a less expensive variant, the fluoropolymer is a polyvinylidene fluoride (PVDF).

Preferably, the polyamide is a polyamide 12 (PA-12).

This material has mechanical and chemical properties that make it particularly well adapted to protecting the tube from external aggression.

Also preferably, the polyamide is modified to form a hydrogen barrier.

The polyamide of the outer layer then presents low permeability to hydrogen.

Other characteristics and advantages of the invention appear on reading the following description of a particular and non-limiting embodiment of the invention.

### BRIEF DESCRIPTION OF THE DRAWINGS

Reference is made to the sole accompanying figure which is a cross-section through a pipe in accordance with the invention.

### DETAILED DESCRIPTION OF THE INVENTION

With reference to the figure, the tube in accordance with the invention comprises an inner layer 1, a bonding layer 2, an intermediate layer 3, a bonding layer 4, and an outer layer 5.

The inner layer 1 is made of ethylene tertrafluoroethylene (ETFE). In a variant, the inner layer 1 can be made of polyvinylidene fluoride (PVDF).

The intermediate layer 3 is a layer of ethylene vinyl alcohol copolymer (EVOH).

The intermediate layer 3 is a barrier layer against oxygen. The oxygen barrier function is exerted against the oxygen coming from the fluid and the oxygen coming from outside the duct so as to protect the inner layer 1 from corrosion.

Advantageously, the material of the intermediate layer 3 presents low permeability to hydrogen and to fuel.

The outer layer 5 is a layer of modified polyamide (PA), in this case polyamide 12 (PA-12). The outer layer 5 performs two functions: it protects the tube against external aggression, and it constitutes a barrier against hydrogen. This material naturally presents good mechanical and chemical properties for performing its protection function. The polyamide used is in addition modified in known manner so as to be impermeable to hydrogen and thus constitute a hydrogen barrier layer, and also make it impermeable to water vapor.

The bonding layers 2 and 4 are made of the same material that possesses good properties of adhesion relative to EVOH, ETFE, and PA-12. In this case, the material of the bonding layers is based on modified polyamide so as to be capable of adhering to all three of the above-mentioned materials. This material presents good resistance to hydrogen and to moisture.

Naturally, the invention is not limited to the embodiment described and variant embodiments can be applied thereto without going beyond the ambit of the invention as defined by the claims.

In particular, the tube of the invention may also be used for transporting fuel.

Furthermore, the tube may include other intermediate layers, in particular between the inner layer 1 of fluoropolymer and the intermediate layer 3 of EVOH.

Furthermore, the bonding layer 4 is optional if the polyamide of the outer layer 5 is modified so as to adhere to the EVOH of the intermediate layer 3.

What is claimed is:

1. A tube comprising an inner layer of fluoropolymer, an intermediate layer of ethylene vinyl alcohol copolymer, and an outer layer of polyamide.

2. A tube according to claim 1, wherein the fluoropolymer is an ethylene tetrafluoroethylene.

3. A tube according to claim 1, wherein the fluoropolymer is a polyvinylidene fluoride.

4. A tube according to claim 1, wherein the polyamide is a polyamide 12.

5. A tube according to claim 1, wherein the polyamide is modified to form a hydrogen barrier.

6. A tube according to claim 1, including a bonding layer bonding the intermediate layer to the inner layer.

7. A tube according to claim 1, including a bonding layer bonding the intermediate layer to the outer layer.

8. A tube according to claim 6, wherein the bonding layer is based on polyamide modified to bond to the adjacent layers.
